(19) United States
(12) Patent Application Publication
(10) Pub. No.: US 2012/0286588 A1
(43) Pub. Date: Nov. 15, 2012

(54) MEMS SWITCHING CIRCUIT

(75) Inventors: Peter Steeneken, Valkenswaard (NL); Olaf Wunnicke, Eindhoven (NL); Klaus Reimann, Eindhoven (NL); James Raymond Spehar, Chandler, AZ (US); Michael Joehren, Pinneberg (DE); Gerrit Willem den Besten, Eindhoven (NL)

(73) Assignee: NXP B.V., Eindhoven (NL)

(21) Appl. No.: 13/105,675

(22) Filed: May 11, 2011

(51) Int. Cl. H01H 9/00

(52) U.S. Cl. 307/115

(57) ABSTRACT

A switching circuit employs MEMS devices. In connection with various example embodiments, signal switching circuit couples primary and secondary data link connectors having at least two channels and an electrode for each channel. A MEMS switch is coupled to each channel in of the secondary data link connectors, and includes a suspended membrane, first and second contact electrodes (one being in the membrane) and a biasing circuit that biases the membrane for moving the membrane between open and closed positions to contact the electrodes. A switch controller circuit selectively controls the application of an actuation voltage to each of the biasing circuits, thereby selectively actuating the membranes between the open and closed positions for routing signals between the primary and secondary data link connectors.

Various aspects of the present invention are directed to switches, and more particularly to multiplexer circuits including MEMS-based switches.

The demand for higher data rates and bandwidth in electronic devices and in electronic communications continues to rise. In particular, the data rate of standards for the transmission of digital signals has been continually increasing. For instance, recent versions of the PCI Express bus (e.g., 3.0) requires a transmission rate of 8 Gb/s. The USB 3.0 standard supports 5 Gb/s. Such standards are pushing towards (and beyond) 10 Gb/s, and are expected to continue to increase.

While the demands upon communication speed have been increasing, circuits used to terminate and switch communication lines have experienced difficulties in meeting bandwidth, loss and other characteristics pertaining to these communications. Most broad frequency bandwidth switches, such as transistor-based switches, behave as a resistor when closed, and as a capacitor when open. Low resistance and capacitance can be desirable, but can be limited due to the voltage levels of signals that are passed via the transistor-based switches. It has been challenging to reduce both closed/on resistance and off/open capacitance while achieving desirable voltage signal values. For example, increasing the area of a transistor can reduce its resistance, but increase its capacitance such that the product remains of resistance and capacitance remains roughly constant. Other approaches to reducing this resistance-capacitance product can adversely affect achievable signal voltage.

Accordingly, the implementation of switching circuits in a variety of applications, and particularly for high-bandwidth applications, continues to be challenging.

Various example embodiments are directed to MEMS switching circuits for a variety of applications and addressing various challenges, including those discussed above.

Various embodiments are directed to a signal switching circuit having primary and secondary data links, a MEMS switch for each channel of each secondary data link and a switch controller circuit. The primary data link has at least two channels and an electrode for each channel, and the secondary data links, having a number of channels that matches the number of channels of the primary data link connector, and an electrode for each channel as well. The MEMS switches include a suspended membrane having a contact electrode that moves relative to a contact electrode on the substrate, between an open position and a closed position for respectively blocking and passing signals between one of the electrodes of the primary data link connector and one of the electrodes of the secondary data link connector. The contact electrodes are respectively coupled to the one of the electrodes of the primary data link connector and to the one of the electrodes of the secondary data link connector. A voltage biasing circuit biases the membrane and thereby causes the membrane to move between the open position in which the contact electrodes are electrically isolated, and the closed position in which the contact electrodes are electrically coupled. In the closed position, the switches pass a signal between the one of the electrodes of the primary data link connector and the one of the electrodes of the secondary data link connector. A switch controller circuit selectively controls the application of an actuation voltage to each of the biasing circuits, thereby selectively actuating the membranes between the open and closed positions for routing signals between the primary data link connector and at least one of the secondary data link connectors.

Another example embodiment is directed to a high-speed communications circuit having a printed circuit board, a logic circuit on the printed circuit board and a multiplexer. The multiplexer includes a substrate and a plurality of multi-channel input/output (I/O) ports, each port having a common number of channels. A primary one of the I/O ports is coupled to the logic circuit, and secondary ones I/O ports are configured for coupling to external devices. The multiplexer includes a plurality of MEMS switches, including a switch coupled to each channel of each I/O port for coupling to external devices. Each switch has a contact on the substrate, and a membrane suspended in a hermetically sealed cavity and having an electrical contact. The membrane also includes an electrode configured to, in response to a bias, move the membrane towards the substrate to connect the contacts for passing signals between one of the primary I/O ports and one of the secondary I/O ports at a signal loss of less than about 2 dB. The membrane is also configured to retract away from the substrate in an unbiased state to isolate the contacts at an isolation of at least 25 dB. A multiplexer controller selectively applies a voltage to the membrane electrodes to selectively close the MEMS switches for connecting the contacts and routing signals between the logic circuit and the external devices.

Another example embodiment is directed to multiplexer circuit having a plurality of input/output (I/O) channels in groups of at least two channels per group, and a MEMS switch for each channel. Each MEMS switch includes a contact fixed to a semiconductor substrate (e.g., and electrically isolated from the substrate), and a membrane suspended in a hermetically sealed cavity. The membrane has an electrical contact and an electrode that responds to a voltage (in a biased state) by actuating the membrane towards the substrate. This actuation connects the contacts for passing signals between different ones of the I/O channels at a signal loss of less than 2 dB. The membrane is also configured to retract away from the substrate in an unbiased state to provide isolation between the contacts of at least 25 dB. For each group of I/O channels, a control line is connected to the membrane electrode of the MEMS switch connected to each I/O channel in the group, for applying the voltage to the membrane electrode in the biased state of the MEMS switch to concurrently close the MEMS switches for the group of I/O channels.

The above discussion is not intended to describe each embodiment or every implementation of the present disclosure. The figures and following description also exemplify various embodiments.

Various example embodiments may be more completely understood in consideration of the following detailed description in connection with the accompanying drawings, in which:

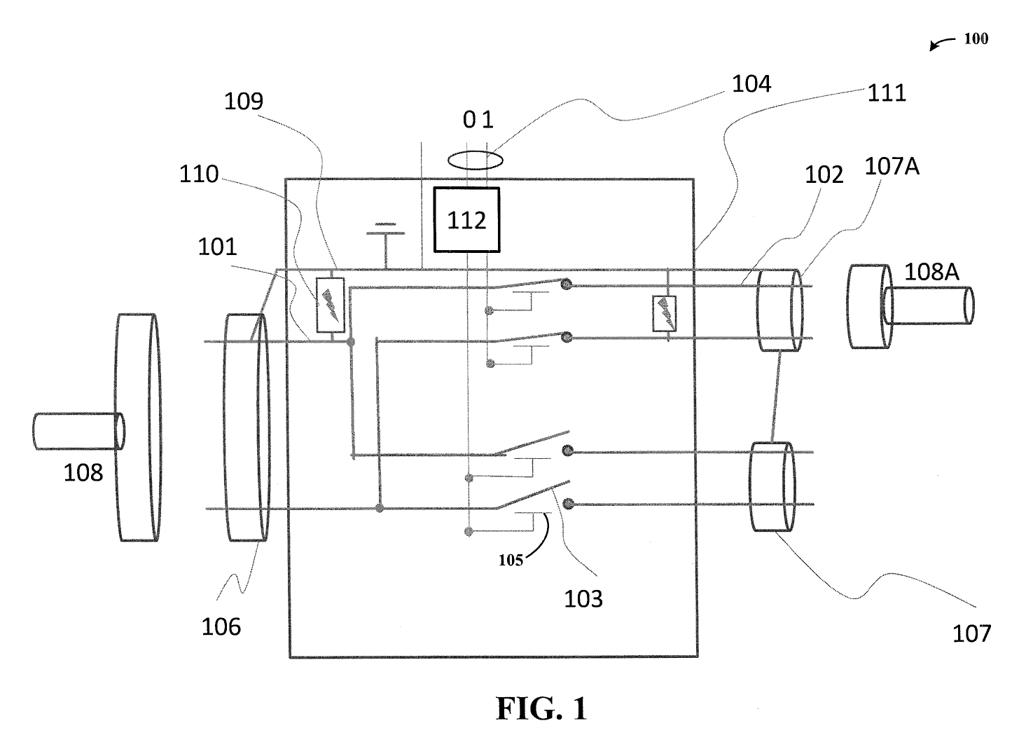

FIG. 1 shows a switching circuit including a plurality of MEMS switches that selectively couple primary and secondary data links, in accordance with another example embodiment of the present invention;

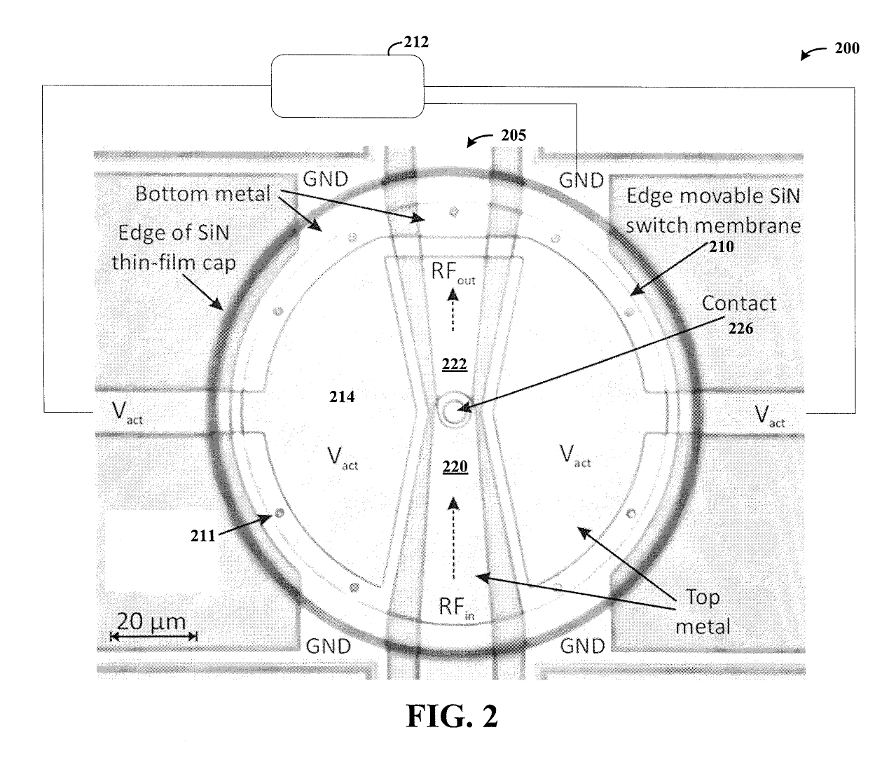

FIG. 2 shows a top view of a MEMS switch for coupling primary and secondary data links as my be implemented with the switching circuit of FIG. 1, in accordance with another example embodiment of the present invention;

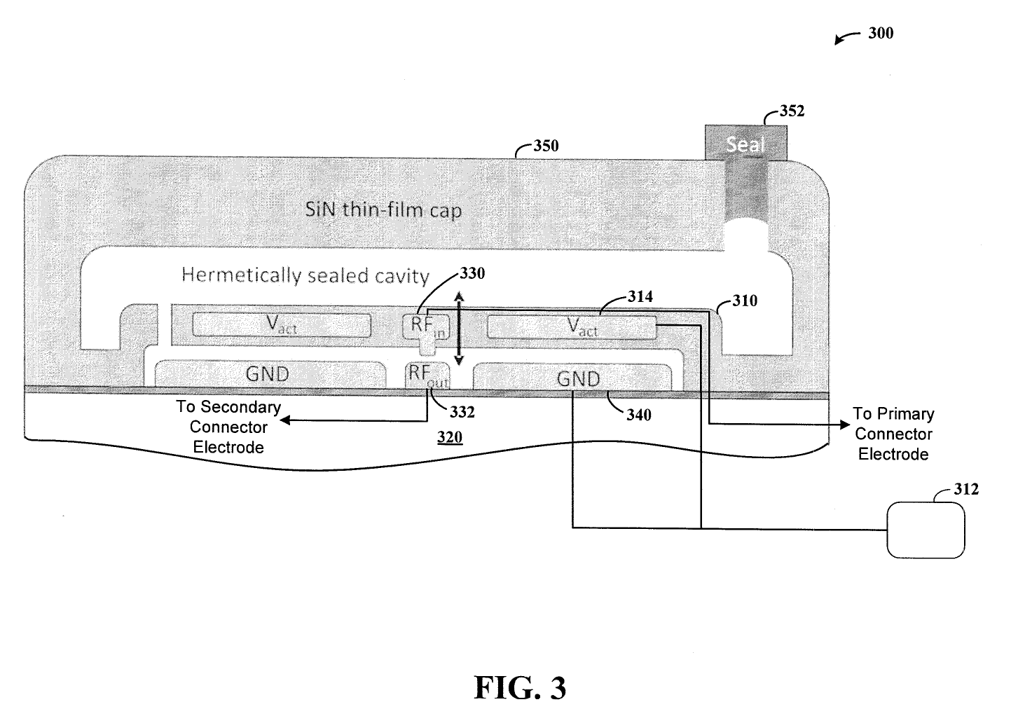

FIG. 3 shows a cross-sectional view of a MEMS switch and package for coupling primary and secondary data links as may be implemented with the switching circuit of FIG. 1, in accordance with another example embodiment of the present invention;

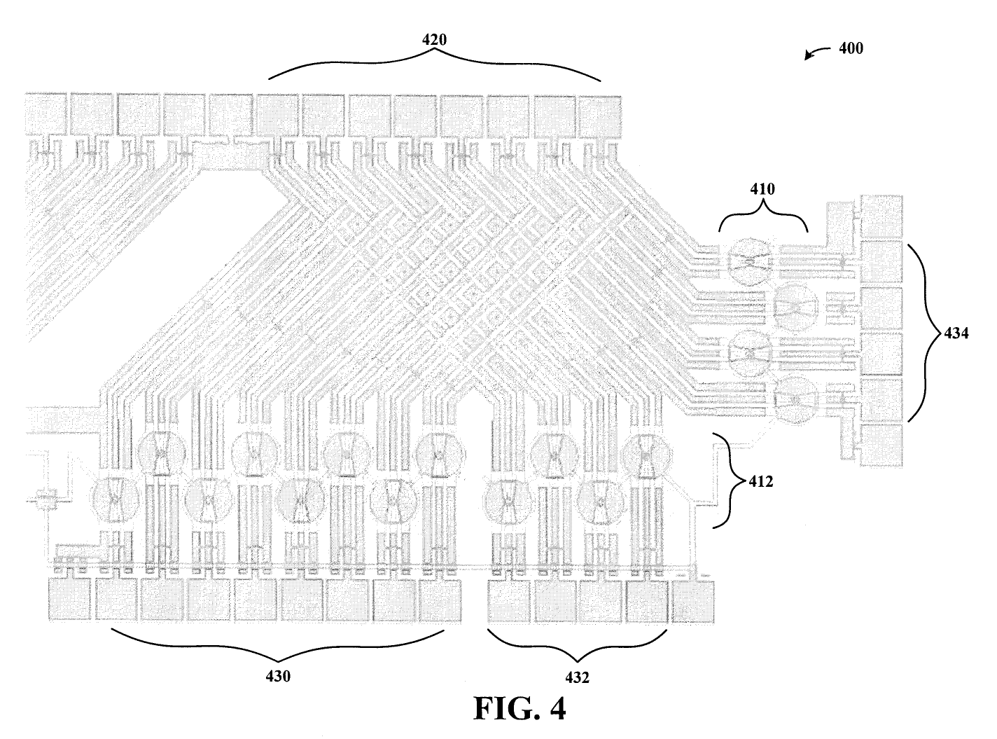

FIG. 4 shows a top view of a multiplexer circuit with 8 inputs and 2×8 outputs, in accordance with another example embodiment of the present invention;

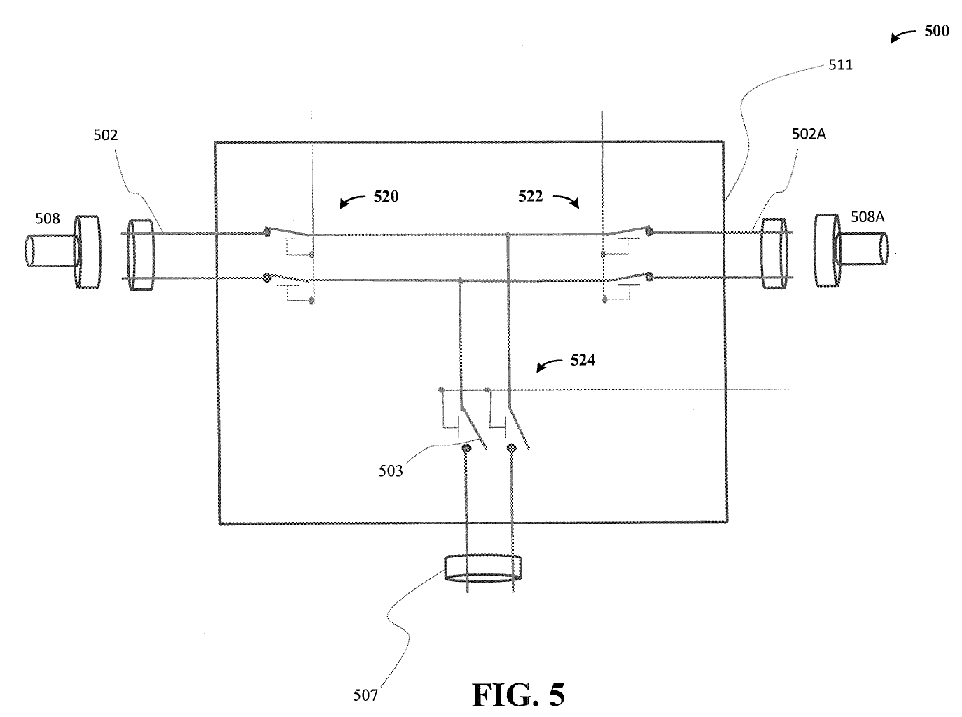

FIG. 5 shows a switching circuit having three input/output ports all having MEMS switches for routing data therebetween, in accordance with another example embodiment of the present invention;

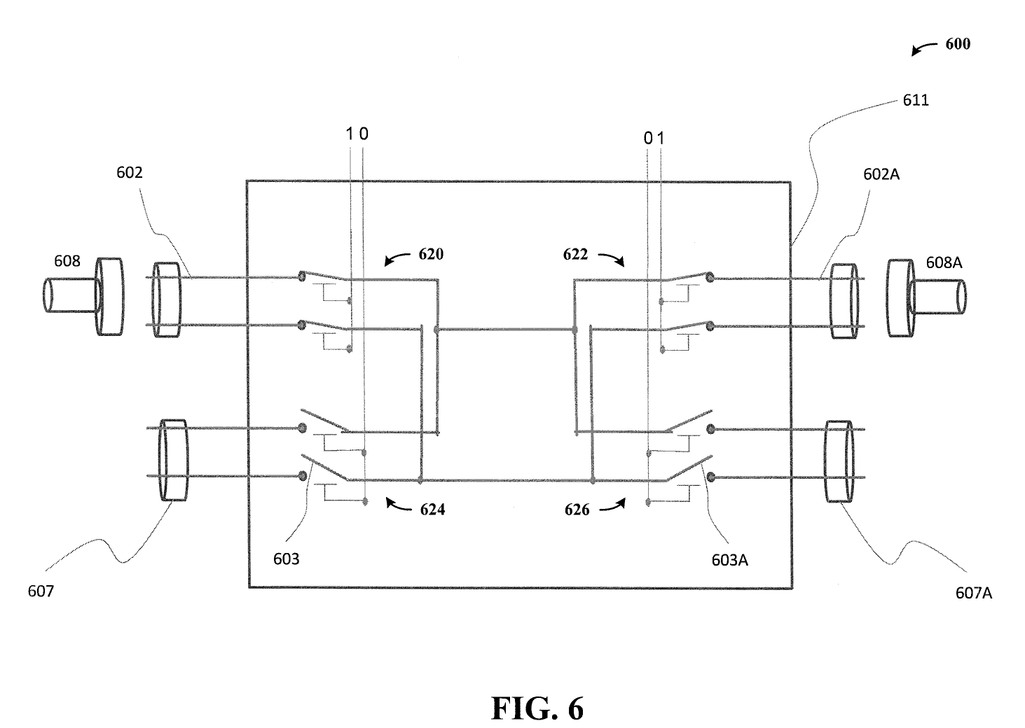

FIG. 6 shows a switching circuit having input/output ports all having MEMS switches for routing data between any of the input/output ports, in accordance with another example embodiment of the present invention;

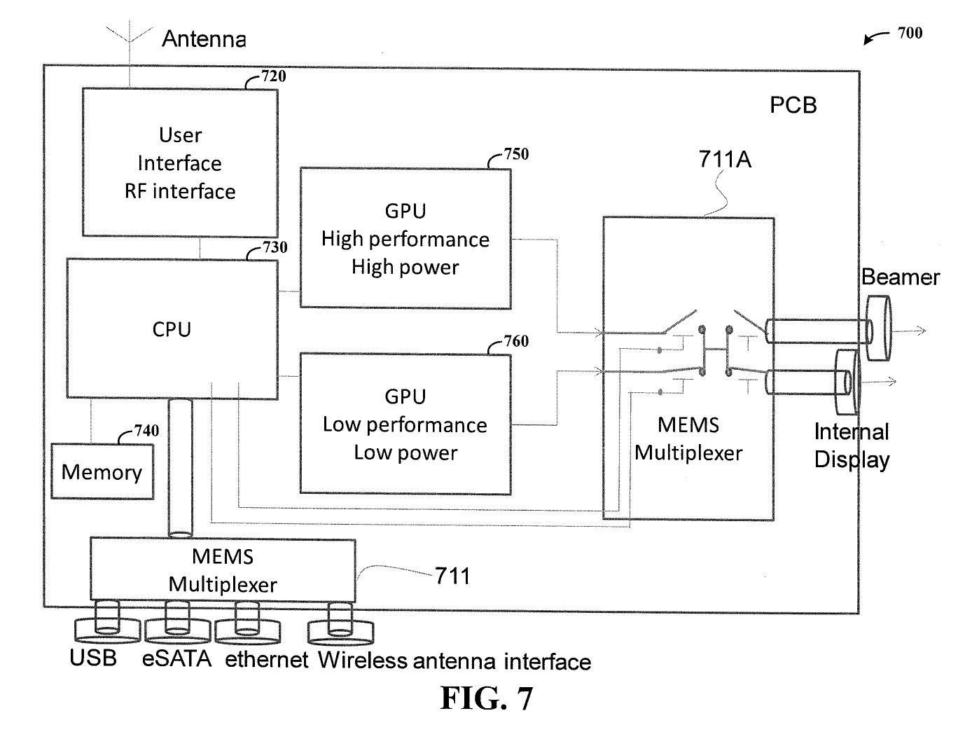

FIG. 7 shows a circuit arrangement for communicating and processing signals with MEMS-based multiplexers, in accordance with another example embodiment of the present invention;

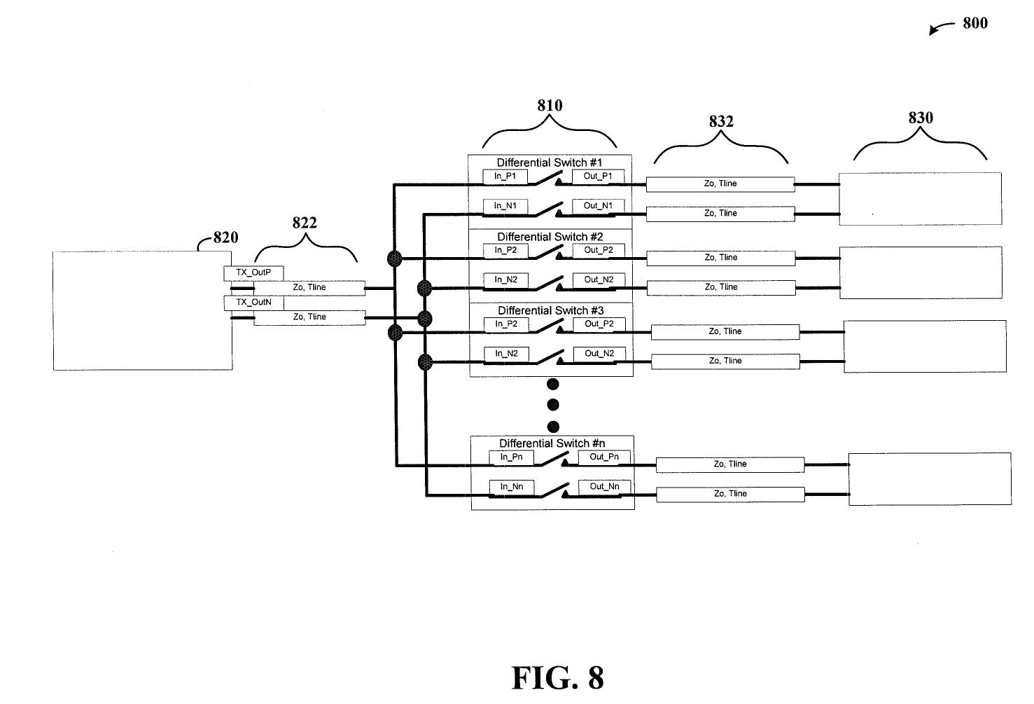

FIG. 8 shows a high-speed, differential digital MEMS switching arrangement, in accordance with another example embodiment of the present invention;

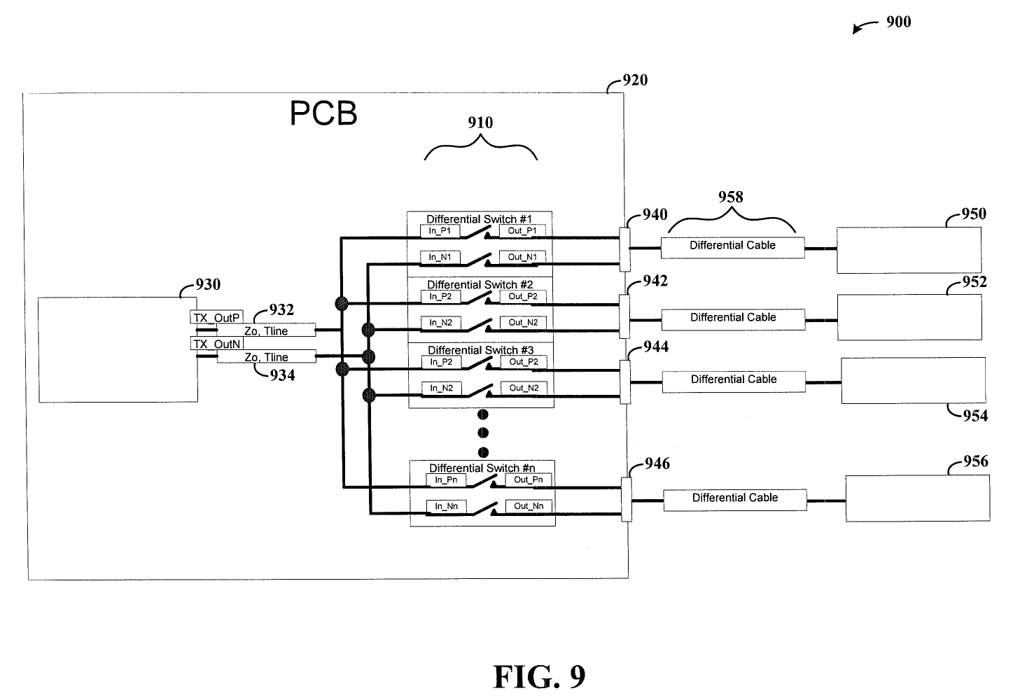

FIG. 9 shows a computer arrangement having a plurality of MEMS-based switches for selectively coupling to a plurality of different types of external devices, in accordance with another example embodiment of the present invention; and

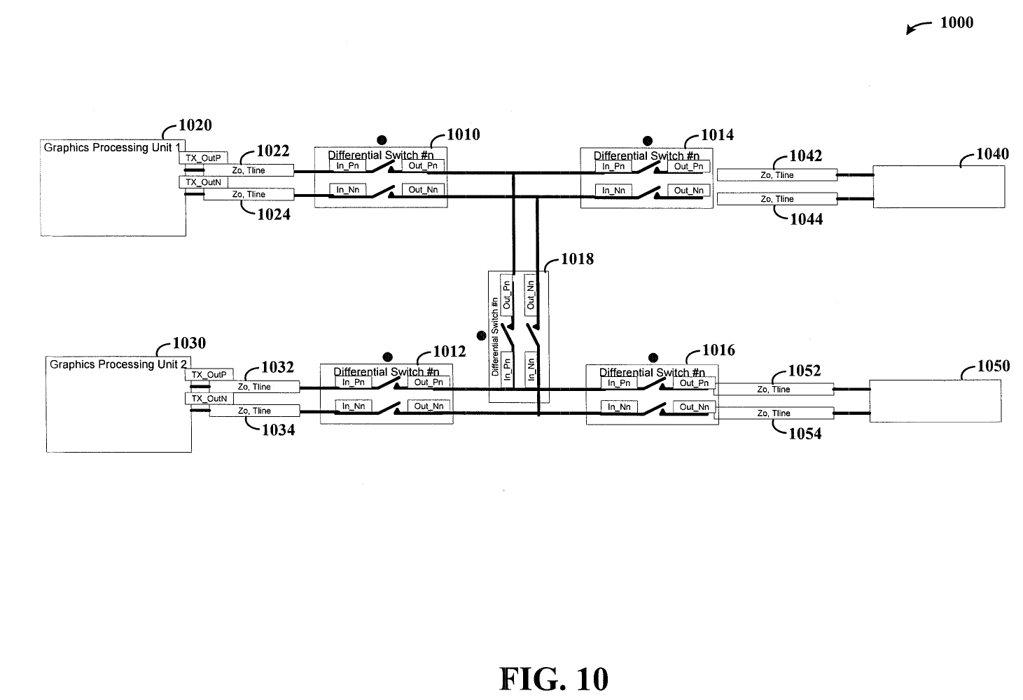

FIG. 10 shows a MEMS-switched controller for selectively coupling processors and devices, in accordance with another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims. Furthermore, the term “example” as used throughout this document is by way of illustration, and not limitation.

The present invention is believed to be applicable to a variety of different types of circuits, devices and arrangements involving switches or switching components, such as CMOS-based multiplexers and other switching circuits. While the present invention is not necessarily limited in this context, various aspects of the invention may be appreciated through a discussion of related examples.

According to an example embodiment, a switching arrangement includes microelectromechanical systems (MEMS)-based switches and a controller that controls the MEMS-based switches for routing signals between circuit components. Each of the MEMS-based switches includes a membrane that moves between open and closed positions in response to an applied voltage. In the closed position, the membrane electrically couples electrodes for passing signals between circuit components to which the particular MEMS-based switch is connected. In the open position, the membrane provides a positioning of the electrodes that blocks (e.g., mitigates) the passing of signals between the electrodes and, correspondingly, between the circuit components.

The controller selectively operates the MEMS-based switches, relative to other MEMS-based switches, to independently couple an input signal to one of two or more outputs. Where dual-channel or multi-channel communications are effected, each output has a number of MEMS-based switches corresponding to the number of channels, and the controller switches the MEMS-based switches to couple all channels of a particular input (e.g., one-by-one) to channels of a particular output. These approaches can be used to facilitate the routing of signals from an input/source to one or more of a plurality of outputs, in a multiplexing-type function.

The switching arrangement can be implemented on a variety of different types of substrates/materials. For example, silicon, glass, ceramic, alumina, sapphire, GaAs, GaN, SiC, ceramics such as LTCC and HTCC, and other substrates can be used alone or in combination to suit particular applications. Various embodiments directed to semiconductors substrates may be implemented with one or more components in the substrate.

In some embodiments, a silicon-based multiplexer includes CMOS-compatible MEMS-based ohmic switches integrated on a semiconductor substrate (e.g., silicon), and uses additional CMOS-type structures for interconnecting and operating the MEMS-based ohmic switches. In this context, the MEMS-based switches can be implemented in place of transistors for a variety of devices, to facilitate high bandwidth communications while both mitigating signal loss and facilitating isolation. In connection with these and other embodiments, it has been discovered that MEMS-based switches can be used to multiplex signals under these conditions, at adequate switching rates and high bandwidth to suit a variety of applications including those for which available bandwidth via transistor-based multiplexers can be inadequate.

A variety of switching connections can be made using one or more embodiments as discussed herein, with MEMS-based switches used to selectively couple channels from a source with one or more output ports/links for effecting a variety of different types of communications. Accordingly, for N (two or more) first electrodes corresponding to a source signal channel, there are K groups of N second electrodes for passing the source signal to an output port. MEMS switches are coupled between each second electrode and a corresponding one of the first electrodes, for switching the N first electrodes to two or more output ports. Accordingly, for a two-channel signal, each output port has two channels each having a MEMS switch coupled thereto, for respectively coupling each of the output ports' channels to one of the channels providing the two-channel signal. A controller actuates the MEMS switches to connect one or more output ports for receiving the two-channel signal, thus providing multiplexed switching for the two-channel signal. Similar approaches can be carried out for signals having more than two channels, with additional electrodes and corresponding MEMS switches. In addition, two or more source signals can be selectively switched using additional MEMS switches on the input side.

The MEMS switches are actuated via a voltage bias applied by a controller to selectively control the state (open/closed) of each MEMS switch. This voltage bias can be applied, for example, to effect an electrostatic or piezoelectric bias to move a membrane having an electrode therein, to bring the electrode in contact with another electrode and/or to move break contact of the electrodes.

The MEMS-based switches are implemented using one or more of a variety of components, generally involving an ohmic or metal-contact material to achieve wide bandwidth. In various contexts, the switches are configured to achieve a resistance in the on/closed state that is less than 3 Ohms, and an insertion loss of less than about 2 dB. In the off/open state, the switches are configured to achieve an isolation between electrodes of at least 25 dB. These characteristics can be achieved for signals in a frequency range from 0 Hz to above 10 GHz. This approach may be implemented to facilitate connection to cables carrying high data rate digital signals, such as for PCI Express, DisplayPort, HDMI, eSATA, or USB 3.0. Such a data rate may include, for example, a rate higher than 2 Gb/s, higher than 5 Gb/s, or higher than 10 Gb/s. In some implementations, each channel is designed to operate as a 50 Ohm transmission line between the frequencies 100 kHz and 10 GHz when a corresponding MEMS switch is closed. In accordance with these implementations, it has been discovered that the implementation of MEMS-based switches with membranes as discussed herein (e.g., at exhibited distances of separation), can be used to achieve such data rates, signal loss and other transmission characteristics as described above.

A variety of different types of signals can be switched using MEMS-based switching circuits as discussed herein. For example, both single-ended and differential signals can be passed, with single-ended signals carrying a signal voltage on one line and holds the other line at ground, and with differential signals using pairs of switches to pass signals of opposite polarity. The switches may pass digital binary signals composed of arbitrary sequences of two voltage levels (e.g., 3V=1 and 0 V=0), direct current (DC) signals, radio frequency (RF) signals, and bidirectional signals as well. In connection with various embodiments, MEMS-based switches having a resistance that depends very little on the amplitude or sign of the signal voltage are used to achieve desirable linearity, maintain the shape of the electrical waveform, permit negative voltages to pass through the switch and simplify differential signal circuit designs.

Turning now to the Figures, FIG. 1 shows a switching circuit 100 having a plurality of MEMS switches that selectively couple primary and secondary data links, in accordance with another example embodiment of the present invention. The switching circuit 100 includes a primary data link connector 106 for connecting to a signal cable 108, having two electrodes that carry a signal received thereat. The electrodes of the primary data link connector 106 are coupled via MEMS-based switches (103 labeled by way of example) to each of two secondary data link connectors 107 and 107A, also each having a pair of electrodes and to which signal cables (e.g., 108A) may also be connected. Accordingly, with the switches coupled to the secondary data link connector 107A closed, a corresponding signal line at 101 is coupled from the primary data link connector 106 to the signal line 102 at the secondary data link connector.

A voltage controller 112 generates and controls the actuation voltage on each of the MEMS switches, using an input at 104. Referring to MEMS switch 103, the voltage controller 112 applies a biasing voltage to biasing circuit 105, to cause the switch 103 to move between open and closed positions and selectively couple the primary data link connector 106 with the secondary data link connector 107. In some implementations, the controller 112 includes a charge pump (e.g., in a common semiconductor substrate) that increases the actuation voltage by a factor of about 20.

The data link connectors in the circuit 100 may be configured/coupled in a variety of manners. In some implementations, one or more connections between the grounds of the different data link connectors 106, 107 and 107A are made, such as shown at 109 by way of example. In other implementations, one or more connectors is coupled to an ESD protection circuit such as shown at 110 (also by way of example).

In still other implementations, an electrode or electrodes of one or more of the data link connectors are connected with a resistor (e.g., 50 Ohms) to ground via an additional MEMS switch that is controlled (e.g., via controller 112) to provide a resistive termination to ground when the switch coupled to the electrode is open. These resistive terminations can be used to absorb signals and thus improve isolation.

As discussed above, various MEMS-based switches as discussed herein can be implemented using CMOS types of processes. In this context, the switching circuit 100 can be formed on a common substrate (e.g., silicon) or printed circuit board as represented at 111. Accordingly, electrodes at 101, 102, 104 and 109, voltage controller 112 and (if implemented) ESD can be integrated on the same substrate with the various MEMS-based switches.

In certain embodiments, the connections interconnecting the MEMS-based switches and other components are configured to mitigate increased connection length as may be used for certain applications (e.g., a length from the junction to the switch). In some implementations, line impedance is increased, such as by thinning a center conductor of a coplanar waveguide, between the junction and the switch.

FIG. 2 shows a top view of a MEMS-based switching arrangement 200 for coupling primary and secondary data links, in accordance with another example embodiment of the present invention. The switching arrangement 200 may, for example, be implemented with the switching circuit of FIG. 1. The arrangement 200 includes a MEMS switch 205 having a membrane 210, such as a 700 nm SiN layer (e.g., formed via PECVD. Electrodes 220 and 222 (e.g., 250 nm thick gold electrodes) are selectively coupled to one another via actuation of the membrane 210. A copper electrode below the electrodes is processed (e.g., planarized at 3 μm thick via chemical-mechanical polishing) to exhibit reduce the resistance of the interconnect and the switch. The membrane 210 has sacrificial holes of a diameter of about 2 μm distributed along the edge of the membrane, with hole 211 labeled by way of example. For general information regarding membranes and MEMS switches, and for specific information regarding MEMS switches that may be implemented in connection with one or more example embodiments herein, reference may be made to Wunnicke et al., “Small, Low-ohmic RF MEMS with Thin-film Package,” Proc. IEEE MEMS 2011, Jan. 23-27 2011, which is fully incorporated herein by reference.

The switching arrangement 200 also includes a controller 212, which may be implemented in a manner similar to that of controller 112 in FIG. 1, for controlling the MEMS switch 205. The controller 212 is coupled to supply an actuation voltage across top metal electrode 214, to cause the membrane 210 to deflect towards the underlying electrode and make contact at a central contact 226 for connecting electrodes 220 and 222.

The size of the switch 205 can be set to suit particular applications and communication needs. For example, the membrane 210 can be implemented at a diameter of between about 25 μm and 90 μm, or larger or smaller to suit applications. In various implementations, the switch 205 is located on an area of a semiconductor substrate that is at least 100 μm² and less than 10000 μm². The membrane 210 is also arranged relative to the substrate to suit applications, and in some implementations, is arranged such that a gap size between the electrodes 220 and 222 is about 300 nm. In other implementations, the membrane 210 is arranged to position the contact 226 and underlying contact for the electrodes 220 and 222 at a distance of at least 100 nm and less than 200 nm, to achieve desirable on/off circuit characteristics in connection with a limited switch size.

FIG. 3 shows a cross-sectional view of a MEMS switch 300 and related switching components including controller 312 for coupling primary and secondary data links, in accordance with another example embodiment of the present invention. The MEMS switch 300 may, for example, be implemented in accordance with the switching circuit of FIG. 1 as discussed above as one of the switches (103). The switch 300 includes a movable membrane 310 suspended over a substrate 320 (shown cut away), and configured for blocking and passing signals via contacts 330 and 332. The membrane 310 is sealed by a silicon nitride cap 350 and seal 352, which form a hermetically sealed cavity.

The controller 312 is coupled to an electrode 314 in the membrane 310, and to ground 340 to apply a bias for actuating the membrane and selectively contacting the contacts 330 and 332. Contact 330 is connected to a primary connector electrode, and contact 332 is connected to a secondary connector electrode. When the controller 312 applies a bias to actuate the membrane 310 and couple contacts 330 and 332 together, a signal is passed between the primary and secondary connector electrodes. When the bias is released, the membrane 310 moves to an unbiased state and decouples the contacts 330 and 332, blocking signals from passing between the connector electrodes. Blocking, in this context, generally applies to isolating the electrodes in a manner that mitigates or prevents signal coupling therebetween (e.g., as discussed above, isolate the electrodes at a level of at least 25 dB).

Another example embodiment, which may be implemented in a manner generally consistent with that shown in and described in connection with one or more of FIGS. 1-3, is directed to a signal switching circuit for switching signals between a primary data link connector and multiple secondary data link connectors. The switching circuit includes, as indicated, such a primary data link connector that has at least two channels and an electrode for each channel, and a plurality of such secondary data link connectors having a number of channels that matches the number of channels of the primary data link connector, and also with an electrode for each channel. The switches are formed on (e.g., at/in a surface of) a semiconductor substrate, which includes other (e.g., CMOS-based) circuits.

The circuit includes a MEMS switch (e.g., at 103 in FIG. 1, 205 in FIG. 2 or 300 in FIG. 3) for each channel of each secondary data link connector, with each MEMS switch including components as follows. A suspended membrane is configured to move relative to the substrate between an open position and a closed position for respectively blocking and passing signals between one of the electrodes of the primary data link connector and one of the electrodes of the secondary data link connector. First and second contact electrodes are respectively coupled to the one of the electrodes of the primary data link connector and to the one of the electrodes of the secondary data link connector. One of the contact electrodes is located in the membrane (e.g., embedded in or at a surface of a partially conductive membrane), and the other one of the contact electrodes is located in the substrate (e.g., also embedded in or at a surface thereof).

A biasing circuit biases the conductive membrane and thereby causes the membrane to move between the open position in which the contact electrodes are electrically isolated, and the closed position in which the contact electrodes are electrically coupled. When the contacts are coupled, they pass a signal between the one of the electrodes of the primary data link connector and the one of the electrodes of the secondary data link connector.

A switch controller circuit selectively controls the application of an actuation voltage to each of the biasing circuits, based upon desired connectivity. Accordingly, the membranes are selectively actuated between open and closed positions for routing signals between the primary data link connector and at least one of the plurality of secondary data link connectors.

In various implementations, the switch controller includes two or more voltage controllers that generate and apply an actuation voltage to the biasing circuit of one of the MEMS switches. For example, a particular voltage controller may be used to apply a voltage to a pair of MEMS switches for a particular channel, or two or more such pairs.

In some implementations, the switching circuit, transmission lines and related components therein are configured to connect the primary and secondary data link connectors such that the respective transmission lengths between primary and secondary connectors are about the same. Referring to FIG. 1 by way of example, the transmission lines connecting each of the electrodes for the data link connector 106 to either of data link connectors 107 and 107A, via the MEMS switches, are about the same (under these embodiments).

FIG. 4 shows a top view of a multiplexer circuit 400 with 8 inputs and 2×8 outputs, in accordance with another example embodiment of the present invention. The multiplexer circuit 400 is formed on a silicon substrate. The circuit 400 includes banks of MEMS-based switches (circular) 410 and 412, which can be implemented with switches such as those shown in FIGS. 2 and 3. A bank (group) of 8 input channels 420 are selectively coupled to outputs on respective banks of 8 output channels 430 or 432/434, based upon the configuration of the MEMS switches 410/412. An actuation voltage is applied to the switches using a controller, such as controller 112 in FIG. 1.

FIG. 5 shows a switching circuit 500 having input/output ports 502, 502A and 507 having MEMS switches integrated on a substrate 511 for routing data therebetween, in accordance with another example embodiment of the present invention. The MEMS switches, with switch 503 labeled by way of example, facilitate the selective coupling or isolation of any of the input/output ports.

Accordingly, by actuating two of the MEMS switches, connection between the ports can be made. For example, when MEMS switch pairs 520 and 522 connecting ports 502 and 502A are actuated, signals are passed between connectors 508 and 508A when connected to the respective ports 502 and 502A. With switch pair 524 deactivated, port 507 is maintained isolated while ports 502 and 502A are coupled.

FIG. 6 shows a switching circuit 600 having input/output ports all having MEMS switches integrated on a substrate 611, for routing data between any of input/output ports 602, 602A, 607 and 607A, in accordance with another example embodiment of the present invention. Each of the input/output ports is selectively coupled via MEMS switch pairs 620, 622, 624 and 626 as shown.

By closing any two of the MEMS switch pairs, signals at the respective ports are coupled. For example, a signal provided via connector 608 at port 602 is coupled to connector 608A at port 602A when MEMS switch pairs 620 and 622 are closed. Each switch couples an electrode of one of the respective ports (e.g., a signal at switch 603 may be coupled to switch 603A when MEMS switch pairs 624 and 626 are closed).

FIG. 7 shows a circuit arrangement 700 for communicating and processing signals, in accordance with another example embodiment of the present invention. The circuit arrangement 700 includes MEMS-based multiplexers 711 and 711A that pass signals between internal components and external ports. The circuit 700 also includes a user or RF interface 720, a CPU 730, memory 740, and both high-power and low-power graphical processing units (GPU) 750 and 760, for use with devices such as computers, mobile phones or other mobile devices. The MEMS-based multiplexers 711 and 711A may, for example, be implemented using one or more embodiments as discussed herein, such as the switches and controllers discussed in connection with FIGS. 1-4.

As consistent with the above discussion, the MEMS-based multiplexers 711 and 711A can be used to selectively couple components of the circuit arrangement 700 with one or more of a variety of external connectors and various ports. By way of example, multiplexer 711 is shown coupling the CPU 730 to one or more of a USB port, eSATA port, Ethernet port or wireless antenna interface port. Also by way of example, multiplexer 711A is shown coupling one of the GPUs 750 and 760 to one of an internal display port or a beamer (e.g., projector) port.

FIGS. 8-10 show high-speed, differential digital MEMS switching arrangements, in accordance with other example embodiments of the present invention. The switching arrangements in these figures thus may be controlled using a controller as discussed hereinabove, such as the controller 112 in FIG. 1. Beginning with FIG. 8, a plurality of high-speed MEMS switches 810 couple a circuit component 820 to one or more devices 830, via dual-channel differential signal lines 822 and 832, and corresponding ports to which the signal lines are connected. The circuit component 820 may, for example, include a CPU, memory controller, graphics processing unit, or baseband circuit. The respective signal lines may be implemented with an impedance Z₀ (e.g., 50 Ohm), and use one or more of a variety of communications standards such as those discussed above (e.g., USB 3.0), DisplayPort (DP) version 1.2, serial attached SCSI (SAS) 3.0, or other high speed differential signal standards. The end devices 830 may include, for example, memory, a monitor or other device.

FIG. 9 shows a computer arrangement 900 having a plurality of MEMS-based switches 910 for selectively coupling signals with a plurality of different types of external devices, in accordance with another example embodiment of the present invention. A device 930 such as a CPU, memory controller, graphics processing unit, or baseband circuit is mounted with the MEMS-based switches 910 on a PCB 920 of a device such as a PC, notebook computer, server, motherboard or mobile phone.

Signal lines 932 and 934 are selectively coupled with one or more of ports 940, 942, 944 and 946 for respectively communicating with devices 950, 952, 954 and 956 via differential cables 958 (e.g., twisted pairs). The respective lines may carry a variety of types of signals using different protocols, such as those described with FIG. 8.

FIG. 10 shows a MEMS-switched controller 1000 for selectively coupling processors and devices, in accordance with another example embodiment of the present invention. The controller 1000 includes MEMS differential switch pairs 1010, 1012, 1014, 1016 and 1018. This combination of switches facilitates the selective coupling of one or both devices 1020 and 1030 with one or both of devices 1040 and 1050. For example, where devices 1020 and 1030 are graphical processing units, either processing unit can be coupled to either (or both) devices 1040 and 1050. This approach can be used, for example, to implement parallel processing, switching between a high-power, high-performance GPU and a low-power, low-performance GPU, faster multitasking, and the display of different movies/images on different devices (1040/1050).

Based upon the above discussion and illustrations, those skilled in the art will readily recognize that various modifications and changes may be made to the present invention without strictly following the exemplary embodiments and applications illustrated and described herein. For example, a variety of different combinations of MEMS-based switches can be made, to suit various connectivity needs for particular applications. In addition, the MEMS-based switches as shown and/or described may be implemented with different types of MEMS switches, facilitating high-bandwidth links between primary and secondary data link connectors (e.g., between input and output signal paths). Such modifications do not depart from the true spirit and scope of the present invention, including that set forth in the following claims.

What is claimed is:

1. A signal switching circuit comprising:
a primary data link connector having at least two channels and an electrode for each channel;
a plurality of secondary data link connectors, each connector having a number of channels that matches the number of channels of the primary data link connector, and an electrode for each channel;
a substrate;
for each channel of each secondary data link connector, a MEMS switch having
a suspended membrane configured to move relative to the substrate between an open position and a closed position for respectively blocking and passing signals between one of the electrodes of the primary data link connector and one of the electrodes of the secondary data link connector,
first and second contact electrodes respectively coupled to pass signals between the one of the electrodes of the primary data link connector and the one of the electrodes of the secondary data link connector, one of the contact electrodes being in the membrane and the other one of the contact electrodes being coupled to the substrate, and
a biasing circuit configured to bias the membrane and thereby cause the membrane to move between the open position in which the contact electrodes are electrically isolated, and the closed position in which the contact electrodes are electrically coupled for passing a signal between the one of the electrodes of the primary data link connector and the one of the electrodes of the secondary data link connector; and
a switch controller circuit configured to selectively control the application of an actuation voltage to each of the biasing circuits, thereby selectively actuating the membranes between the open and closed positions for routing signals between the primary data link connector and at least one of the plurality of secondary data link connectors.

2. The circuit of claim 1, further comprising a termination circuit including
a resistor connected to ground, and
a MEMS switch configured to couple at least one of the electrodes to ground via the resistor under a condition in which the MEMS switch connected to the at least one of the electrodes is in the open position.

3. The circuit of claim 1, wherein the switch controller circuit includes a plurality of voltage controllers, each controller respectively configured to generate and apply an actuation voltage to the biasing circuits of the MEMS switches connected to one of the secondary data link connectors.

4. The circuit of claim 1, wherein the MEMS switches are configured to pass a digital signal between the one of the electrodes of the primary data link connector and the one of the electrodes of the secondary data link connector having a data rate that exceeds 5 Gb/s.

5. The circuit of claim 1, wherein the switch controller is configured to control the application of an actuation voltage to the biasing circuits of the MEMS switches in response to a multiplexing input signal for coupling the digital signal between the primary data link connector and at least one of the secondary data link connectors.

6. The circuit of claim 1, wherein the MEMS switches are configured to couple signals between the primary and secondary data link connectors, the signals including at least one of: bidirectional signals, digital binary signals composed of arbitrary sequences of two voltage levels; signals having a wide-band frequency range between about 0 Hz and 10 GHz; direct current (DC) signals and radio frequency (RF) signals.

7. The circuit of claim 1, wherein the MEMS switches are configured to
electrically couple the electrodes to which they are connected at a resistance that is less than about 3 Ohms and at an insertion loss of less than about 2 dB in the closed position, and
electrically isolate the electrodes to which they are connected at a capacitance of less than 100 fF and at an isolation level that is at least 25 dB, in the open position.

8. The circuit of claim 1, wherein
each primary and secondary data link connector has an even number of electrodes consisting of an electrode pair for each communication link served by the data link connector, the electrodes in each electrode pair being respectively configured to carry differential signals of opposite polarity, and
the switch controller is configured and arranged to simultaneously open and close the MEMS switches connected to each electrode pair.

9. The circuit of claim 1, further including circuits coupling grounds of at least two of the electrodes to one another.

10. The circuit of claim 1, wherein the MEMS switches are configured to transmit signals between 100 kHz and 10 GHz at 50 Ohms when closed.

11. The circuit of claim 1, wherein the switch controller includes a charge pump in the substrate and configured to increase the actuation voltage by a factor of 20.

12. The circuit of claim 1, wherein
each of the MEMS switches is located on an area of the substrate that is at least 100 μm² and less than 10000 μm², and
the membrane is configured and arranged to, in the open position, position the contact electrodes at a distance of at least 100 nm and less than 200 nm.

13. The circuit of claim 1, wherein the data link connectors are connected to the MEMS switches via transmission lines, the total length of the transmission lines connecting the primary data link connector to the secondary data link connectors for each channel being about equal.

14. The circuit of claim 1, further including one of said MEMS switches for each channel of the primary data link connector.

15. The circuit of claim 1, wherein the membrane includes an electrode portion of the biasing circuit that generates a force that moves the membrane in response to the application of a voltage.

16. The circuit of claim 1, further comprising a MEMS switch coupled between one of the MEMS switches and the primary data link connector, to selectively couple the one of the MEMS switches to the primary data link connector.

17. The circuit of claim 1, further comprising a MEMS switch configured to couple signals between two other MEMS switches, the two other MEMS switches including at least one of said MEMS switches for each channel of the secondary data link connector.

18. A communications circuit comprising
a printed circuit board;
a logic circuit connected to the printed circuit board;
a multiplexer connected to the printed circuit board and having
a semiconductor substrate,
a plurality of multi-channel input/output (I/O) ports, each port having a common number of channels, a primary one of the I/O ports being coupled to the logic circuit and secondary ones I/O ports being configured for coupling to external devices,
a plurality of MEMS switches including a switch coupled to each channel of each I/O port for coupling to external devices, each switch having
a contact in the semiconductor substrate, and
a membrane suspended in a hermetically sealed cavity and having an electrical contact, the membrane including an electrode configured to, in response to a bias, move the membrane towards the substrate to connect the contacts for passing signals between one of the primary I/O ports and one of the secondary I/O ports at a signal loss of less than 2 dB, the membrane being configured to retract away from the substrate in an unbiased state to provide an isolation between the contacts of at least 25 dB; and
a multiplexer controller connected to the printed circuit board and configured to selectively apply a voltage to the membrane electrodes to selectively close the MEMS switches for connecting the contacts and routing signals between the logic circuit and the external devices.

19. The circuit of claim 18, further including, for each channel of the secondary I/O ports, a termination circuit including a resistive circuit and a switch coupled in series between an electrode of the secondary I/O port and ground, the switch being configured to close in response to the MEMS switch coupled to the electrode being in an open position.

20. The circuit of claim 18, wherein, for each I/O port, all MEMS switches coupled directly to the I/O port are electrically connected to a common line fed by the multiplexer controller and responsive thereto by concurrently operating in a closed or open position in response to a single output from the multiplexer controller.

21. A multiplexer circuit comprising:
a plurality of input/output (I/O) channels in groups of at least two channels per group;
for each channel, a MEMS switch including
a contact on a substrate, and
a membrane suspended in a hermetically sealed cavity and having an electrical contact, the membrane including an electrode configured to respond to a voltage in a biased state by actuating the membrane towards the substrate to connect the contacts for passing signals between different ones of the I/O channels at a signal loss of less than 2 dB, the membrane being configured to retract away from the substrate in an unbiased state to provide an isolation between the contacts of at least 25 dB; and
for each group of I/O channels, a control line connected to the membrane electrode of the MEMS switch connected to each I/O channel in the group, for applying the voltage to the membrane electrode in the biased state of the MEMS switch to concurrently close the MEMS switches for the group of I/O channels.

22. The multiplexer circuit of claim 21, further including a controller configured to selectively apply the voltage to the membrane electrodes via the control lines, to selectively close the MEMS switches for routing signals between one of the groups of I/O channels and at least another one of the groups of I/O channels.
